(19) United States
(12) Patent Application Publication
(10) Pub. No.: US 2005/0173543 A1
(43) Pub. Date: Aug. 11, 2005

(54) Contactless data storage medium having a signal indicator

(75) Inventors: Stefan Ruping, Lengdorf (DE); Rupert Klement, Rosenheim (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/055,570

(22) Filed: Feb. 9, 2005

(30) Foreign Application Priority Data
Feb. 10, 2004 (DE) 10 2004 006504.7

(51) Int. Cl. G06K 19/06

(52) U.S. Cl. 235/492

(57) ABSTRACT

A contactless data storage medium includes: a coupling element; a data processing unit which is connected to the coupling element and is set up to receive data via the coupling element; and a power supply unit which is connected to the coupling element and is intended to provide electrical power in order to operate the data processing unit. The inventive contactless data storage medium is distinguished by the fact that it includes a signal indicator which can be driven by the data processing unit and/or the power supply unit.

### CROSS-REFERENCE TO RELATED APPLICATION

This application claims priority to German patent application serial No. 102004006504.7, filed Feb. 10, 2004, which is hereby incorporated by reference in its entirety.

### TECHNICAL FIELD

The invention relates to a contactless data storage medium having a coupling element, a data processing unit which is connected to the coupling element and is set up to receive data via the coupling element, and a power supply unit which is connected to the coupling element and is intended to provide electrical power in order to operate the data processing unit.

### BACKGROUND

Contactless data storage media of this type are used, for example, in the form of contactless chip cards. Such chip cards can be used for communication without being inserted into a read/write unit, where the connection between the data processing unit in the chip card and the read/write unit is established via contacts. Whereas, in the case of data storage media having contacts, the electrical power needed to operate the data processing unit is provided via the contacts, data storage media which operate in a contactless manner need to have either a battery, photocells or the like or else they obtain the power needed from the electrical field in the read/write unit, which is also used to transmit the data. Areas of use for contactless chip cards are, for example, their use in access control devices or as a means of payment.

### SUMMARY

The present invention is directed to a data storage medium which affords increased opportunities for use and is characterized and distinguished by the fact that the medium includes a signal indicator which can be driven by the data processing unit and/or the power supply unit.

A signal indicator which, for example, is in the form of an optical signal indicator or a vibration element has various additional opportunities for use. In one advantageous refinement, the signal indicator provided according to one embodiment makes it possible to respond positively to an identification query. If the contactless data storage medium is connected to an object, it is possible to search for that object specifically by virtue of a read/write unit transmitting an identification query. That data storage medium which corresponds to an identification code contained in the identification query indicates this, for example, by lighting up the optical signal indicator, so that the object being sought can be found easily by a user.

In a further advantageous refinement, the data storage medium is set up in such a manner that the signal indicator indicates when a data transmission process is taking place. This is important to a user, for example, in order to be able to ascertain that his contactless data storage medium is being accessed. The beginning and end of a data transmission process can be identified in this manner.

In another, particularly advantageous refinement, the signal indicator may be used as an additional load in order to deliberately consume excess power. This operating situation occurs when the contactless data storage medium is in a very strong field and a high voltage is therefore induced in the coupling element, which is preferably a coil. In order to limit the voltage to such an extent that a voltage level which suits the data processing unit is achieved, a large amount of power needs to be consumed in the power supply unit. If this power is converted solely into heat, the temperature of the contactless data storage medium and of the power supply unit will rise sharply, with the result that the contactless data storage medium may be damaged. Switching in the signal indicator makes it possible for electrical power to be converted into optical or mechanical power, so that additional heating of the contactless data storage medium is avoided. The signal indicator indicates this operating state to the user as a secondary effect.

Further aspects and features of the present invention can be appreciated from the appended Figures and the accompanying written description.

### BRIEF DESCRIPTION OF THE DRAWING FIGURES

The foregoing and other features of the present invention will be more readily apparent from the following detailed description and drawings of the illustrative embodiments of the invention wherein like reference numbers refer to similar elements and in which:

FIG. 1 shows a first exemplary embodiment of an inventive contactless data storage medium,

FIG. 2 shows a second exemplary embodiment of an inventive contactless data storage medium, and

FIG. 3 shows a third exemplary embodiment of an inventive contactless data storage medium.

### DETAILED DESCRIPTION OF PREFERRED EMBODIMENTS

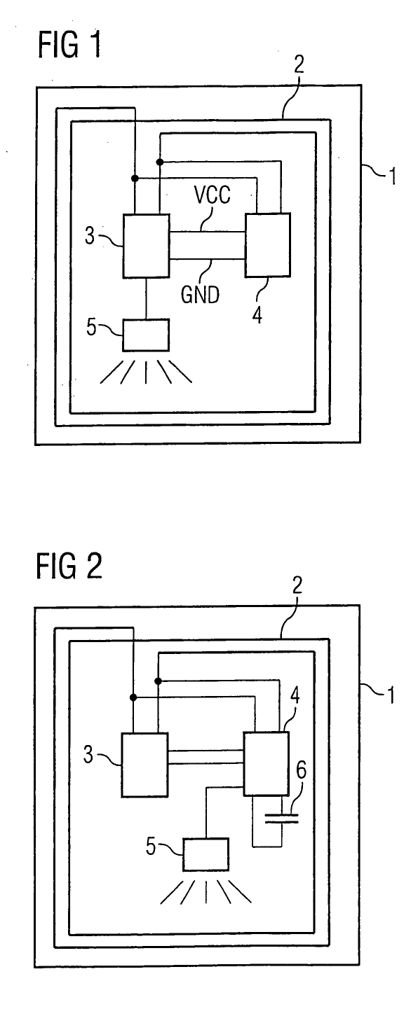

FIG. 1 shows a contactless data storage medium 1 which is provided with a coupling element in the form of a coil 2. A data processing unit 3 and a power supply unit 4 are also provided. Both the data processing unit 3 and the power supply unit 4 are connected to the coupling element 2. Whereas the data processing unit 3 is set up to extract data (which have been transmitted via the electrical field) from the voltage which has been induced in the coil 2, the power supply unit 4 is set up to generate a DC voltage (which can be used to supply the data processing unit 3) from the AC voltage which has been induced. To this end, the AC voltage is rectified and is limited to a suitable voltage level by a voltage regulator. The data processing unit 3 is provided with the rectified and regulated voltage via a connection VCC and GND between the power supply unit 4 and the data processing unit 3.

In accordance with the exemplary embodiment shown in FIG. 1, a signal indicator 5 is provided and is connected to the data processing unit 3 in such a manner that the signal indicator 5 can be driven by the data processing unit 3.

The signal indicator 5 is preferably an optical signal indicator, for example a light-emitting diode. In this case, the light-emitting diode 5 may be physically integrated in the data processing unit 3, which is in the form of an integrated circuit. Even if the circuit is embedded in a plastic card, the light emitted by the light-emitting diode 5 can be detected through the plastic, with the result that this embodiment of a signal indicator 5 can be implemented in a very cost-effective manner.

However, other signal indicators 5 are additionally also possible, for example a vibration element or an acoustic signal indicator. A piezo element may be used in this case.

In one advantageous application of the inventive contactless data storage medium 1, the latter is connected to an object. When there are a lot of objects with contactless data storage media 1, the signal indicator 5 provides optical feedback which reveals one of the data storage media 1 or one of the objects connected to the data storage medium 1 to be a data storage medium 1 or object being sought. This can be used advantageously, for example, in manual assembly areas when a device comprising a plurality of objects is assembled manually. The illumination of the signal indicators 5 in various data storage media 1 makes it possible to indicate to the person assembling the device the order in which the objects connected to the respective data storage media 1 are to be assembled. In this case, a control unit, in which the correct order is stored, successively emits search queries containing the corresponding identification codes.

Another advantageous application is a type of optical position identification. For example, a document being sought in a stack of documents can be found quickly if the correspondingly associated data storage medium uses its signal indicator to emit an optical signal. The contactless data storage media according to the invention are also suitable for file repositories, in which case files which have been stored in the wrong place in the file repository and can therefore be found again only with great difficulty can also be found easily using the optical signal indicator.

In a second exemplary embodiment as shown in FIG. 2, the signal indicator 5 is connected to the power supply unit 4, that is to say it can be addressed directly by the power supply unit 4. In this exemplary embodiment, the use of the signal indicator 5 is for it to be switched in as an additional load in order to consume excess power, as explained above. In the exemplary embodiment shown in FIG. 2, an energy store in the form of a capacitor 6 is additionally provided. When there is excess power, the energy store 6 is first of all charged. If the excess power needs to be “consumed” only for a brief period, buffering using the energy store 6 suffices. After leaving the strong field, the stored energy can be consumed over a longer period of time, so that the data storage medium 1 is not severely heated in an inadmissible manner. However, if excess power is produced over a relatively long period of time and needs to be consumed, the energy store 6 reaches a predetermined charge state in which the signal indicator 5 is switched in for the purpose of consuming additional power.

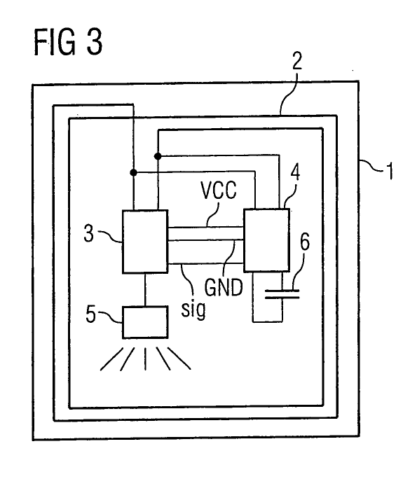

A third embodiment of an inventive data storage medium 1 as shown in FIG. 3 combines the features of the embodiments shown in FIGS. 1 and 2. In this case, the power supply unit 4 uses a signal line “sig” to signal to the data processing unit 3 that an additional load needs to be switched in. The data processing unit 3 then activates the signal indicator 5 to consume excess power. The data processing unit 3 may, of course, also activate the signal indicator 5 for other reasons. In this embodiment, the signal indicator 5 may therefore be used both as an identification aid and as an additional load and thus provides a particularly flexible opportunity for use.

Having described embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A contactless data storage medium comprising:
a coupling element;
a data processing unit which is connected to the coupling element and is set up to receive data via the coupling element;
a power supply unit which is connected to the coupling element and is intended to provide electrical power in order to operate the data processing unit; and
a signal indicator that is configured to be driven by at least one of the data processing unit and the power supply unit.

2. The contactless data storage medium as claimed in claim 1, wherein the signal indicator is an optical signal indicator.

3. The contactless data storage medium as claimed in claim 1, wherein the signal indicator is a vibration element.

4. The contactless data storage medium as claimed in claim 1, wherein the signal indicator is a piezo element.

5. The contactless data storage medium as claimed in claim 1, wherein the data storage medium is set up to switch in the signal indicator as an additional load in order to consume excess electrical power.

6. The contactless data storage medium as claimed in claim 5, wherein an energy store is connected to the power supply unit, and the data storage medium is set up to switch in the signal indicator when a predetermined charge state of the energy store has been reached.

7. The contactless data storage medium as claimed in claim 1, which is set up in such a manner that the signal indicator is used to indicate a positive response to an identification query from a read/write unit.

8. The contactless data storage medium as claimed in claim 1, which is set up in such a manner that the signal indicator indicates a data transmission process.

9. The contactless data storage medium as claimed in claim 1, wherein the coupling element comprises a coil.

10. A contactless data storage medium comprising:
a coupling element;
a data processing unit which is connected to the coupling element and is set up to receive data from voltage induced in the coupling element;
a power supply unit which is connected to the coupling element and is intended to provide electrical power in order to operate the data processing unit, wherein the induced voltage supplied to the data processing unit is rectified and regulated via a connection between the power supply unit and the data processing unit; and
a signal indicator that is configured to be driven by at least one of the data processing unit and the power supply unit and is configured to perform at least one prescribed function.

11. The contactless data storage medium as claimed in claim 10, wherein the signal indicator is directly connected to the power supply unit to permit it to be addressed directly by the power supply unit.

12. The contactless data storage medium as claimed in claim 11, wherein the at least one prescribed function is that the signal indicator acts as an additional load in order to consume excess electrical power.

13. The contactless data storage medium as claimed in claim 10, wherein the at least one prescribed function is that the signal indicator consumes excess power when the power supply unit signals the data processing unit that an additional load needs to be switched in.

14. The contactless data storage medium as claimed in claim 10, wherein the signal indicator comprises an optical signal indicator that is physically integrated into the data processing unit which is in the form of an integrated circuit.

15. The contactless data storage medium as claimed in claim 14, wherein the integrated circuit is embedded in a plastic card.

16. The contactless data storage medium as claimed in claim 10, wherein the medium is associated with an object, with the signal indicator providing optical feedback that reveals one of the data storage medium or one of the object associated with the medium to be one of a data storage medium or object being sought.

17. An identification aid comprising:
a plurality of objects that are to be identified;
a plurality of contactless data storage media having an unique identification code, one contactless data storage medium being associated with one object, wherein each medium includes:
a coupling element;
a data processing unit which is connected to the coupling element and is set up to receive data via the coupling element;
a power supply unit which is connected to the coupling element and is intended to provide electrical power in order to operate the data processing unit; and
a signal indicator that is configured to be driven by at least one of the data processing unit and the power supply unit; and
a control unit in communication with the plurality of contact data storage media such that the control unit is adapted to process a search query resulting in an identification code and identify a target object by having the signal indicator associated with the target object emit an optical signal.

18. The identification aid as claimed in claim 17, wherein the control unit is configured to store a selected identification codes representing an order of combining the objects together, the control unit subsequently and successively emitting search queries containing the corresponding identification codes so as to successively illuminate the signal indicators in various data storage media to indicate the order of combining the objects together.
